(19) United States
(12) Patent Application Publication
(10) Pub. No.: US 2022/0126496 A1
(43) Pub. Date: Apr. 28, 2022

(54) Tandem Foaming Extruder having Improved Throughput Rate

(71) Applicant: MYUNG-IL FOAM TEC CO., LTD., Daegu (KR)

(72) Inventor: Kyoo-Ik NOH, Daegu (KR)

(21) Appl. No.: 17/080,046

(22) Filed: Oct. 26, 2020

(30) Foreign Application Priority Data
Oct. 26, 2020 (KR) 10-2020-0139072

(51) Int. Cl. B29C 48/50; B29C 48/40

(52) U.S. Cl. CPC B29C 48/503; B29C 48/404

(57) ABSTRACT

Disclosed herein is a tandem foaming extruder having an improved throughput rate. The tandem foaming extruder can reduce frictional force against the resin melt and control pressure drop in the cross pipe by forming the low friction coating layer with constant thickness on the inner surface of the cross pipe, which connects the first extruder and the second extruder with each other, thereby increasing the throughput rate per unit time by 10% to 40% compared with conventional tandem foaming extruders for thermosoftening plastics like polystyrene or Nylon resin.

### CROSS-REFERENCE TO RELATED APPLICATION(S)

This patent application claims priority to KR 10-2020-0139072, filed Oct. 26, 2019, the entire contents of which are incorporated herein by reference.

### BACKGROUND OF THE INVENTION

### Field of the Invention

The present invention relates to a tandem foaming extruder, and more particularly, to a tandem foaming extruder having an improved throughput rate per unit time by improving flow characteristics of resin melt in a cross pipe, which connects a first extruder and a second extruder with each other.

### Background Art

Various kinds of thermoplastic resin have been widely used for a variety of purposes by being molded into foamed products with porosity. Therefore, various processes of foaming thermoplastic resin have been developed. There are batch foaming, bead foaming, injection foaming, extrusion foaming, and so on. The extrusion foaming process out of the various foaming processes has been widely applied since having high productivity due to a continuous process.

There are protective packing materials that polyethylene resin or polypropylene resin is foamed in the form of a sheet, various disposable food containers or insulating materials for buildings that polystyrene resin is foamed, and so on.

A tandem foaming extruder, in which two extruders are connected in series through a cross pipe, has been widely used for such an extrusion foaming process. A first extruder serves to melt the thermoplastic resin, which is a raw material, and uniformly mix the thermoplastic resin with a foaming agent and other additives, and a second extruder serves to cool the resin melt discharged from the first extruder to optimal temperature to provide rheological characteristics suitable for foaming.

Basically, a flow of the resin melt in the first and second extruders is caused by a drag flow by a screw wing rotating at constant speed. Moreover, the mechanism that the resin melt discharged from the first extruder is transferred to the second extruder through the cross pipe is caused by a plug flow by pressure.

In general, there is a great pressure drop in the cross pipe of the tandem foaming extruder due to high viscosity of the thermoplastic resin melt used for the extrusion foaming process and high frictional coefficient against the inner surface of the cross pipe made of a metal material.

It is known that such a tandem foaming extruder has a throughout rate of about 30% to 50% which is lower than that of other foaming extruder having the same cylinder size due to a structural limit of the tandem foaming extruder. Therefore, the tandem foaming extruder deteriorates productivity in the whole manufacturing process.

Furthermore, because there is a limit in extending the length of the cross pipe due to the pressure drop in the cross pipe, it is difficult to design a cross pipe optimized for foaming extrusion of plastics which need sufficient mixing time or reaction time for foaming extrusion process.

### SUMMARY OF THE INVENTION

Accordingly, the present invention has been made to solve the above-mentioned problems occurring in the prior arts, and it is an object of the present invention to provide a tandem foaming extruder having an improved throughput rate which can continuously foam and extrude thermoplastic resin and improve a throughput rate per unit time by improving flow characteristics of resin melt in a cross pipe, which connects a first extruder and a second extruder with each other.

To accomplish the above object, according to the present invention, there is provided a tandem foaming extruder having an improved throughput rate, which includes a first extruder, a second extruder, and a cross pipe connecting the first extruder and the second extruder with each other in series, wherein a low friction coating layer with constant thickness is formed on the inner surface of the cross pipe.

In this instance, the low friction coating layer has 0.002 to 2 mm thickness, and is made of any one among hard chromium, nickel, zinc, and nickel Teflon.

Moreover, the cross pipe has 1,500 to 20,000 mm length.

Furthermore, a surface roughness of the inner surface of the cross pipe is within the range of 0.07 to 20 μm based on the center-line average roughness (Ra).

The tandem foaming extruder having an improved throughput rate according to the present invention can reduce frictional force against the resin melt and control pressure drop in the cross pipe by forming the low friction coating layer with constant thickness on the inner surface of the cross pipe, which connects the first extruder and the second extruder with each other, thereby increasing the throughput rate per unit time by 10% to 40% compared with conventional tandem foaming extruders.

Additionally, the tandem foaming extruder having an improved throughput rate according to the present invention can be designed in such a way that the cross pipe is still longer than that of the conventional tandem foaming extruders since decreasing pressure drop in the cross pipe, thereby being applicable to foaming extrusion of nylon resin which require sufficient reaction time to secure productivity.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a view showing a structure of a conventional tandem foaming extruder; and

FIG. 2 is a sectional view of a cross pipe of a tandem foaming extruder having an improved throughput rate according to the present invention.

### DETAILED DESCRIPTION OF THE PREFERRED EMBODIMENT

Hereinafter, an embodiment of the present invention will be described in detail with reference to the accompanying drawings.

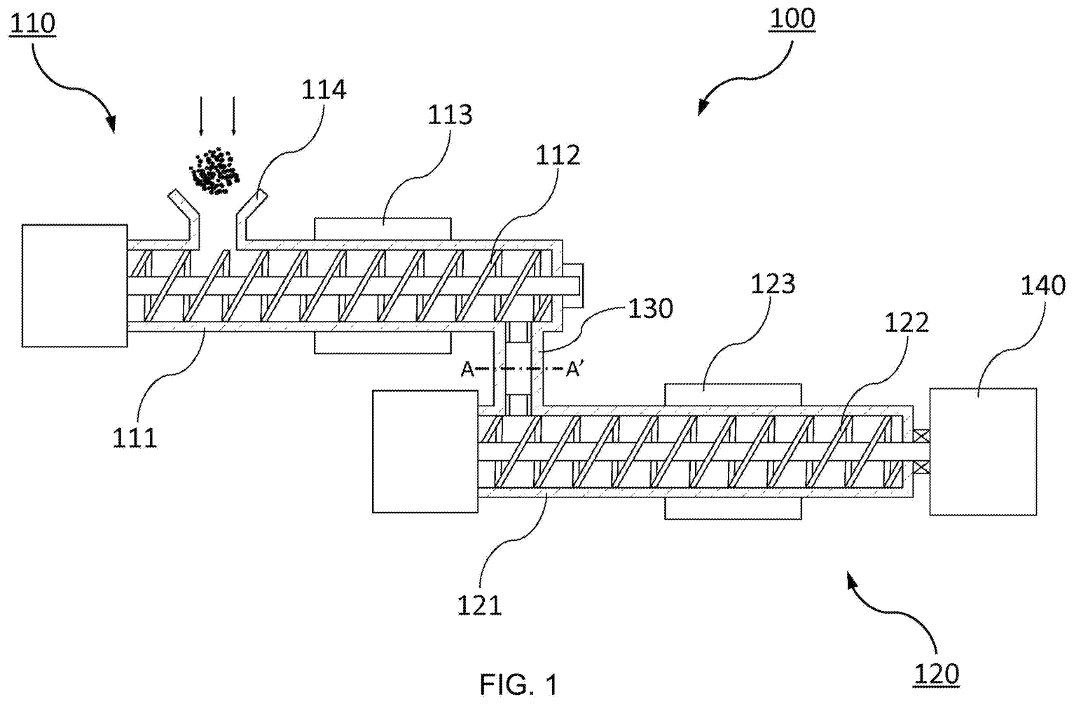

FIG. 1 is a view showing a structure of a conventional tandem foaming extruder 100. The tandem foaming extruder 100 includes a first extruder 110 which receives and melts raw material, and a second extruder 120 connected with the first extruder 110 in series to foam and extrude resin melt transferred from the first extruder 110 while cooling the resin melt to optimal temperatures for reaction.

The first extruder 110 includes a hopper 114 for supplying the raw material, a first cylinder 111 having a first screw 112 rotating by motive power, and a heating device 113 for heating the first cylinder 111 to melt the raw material.

Moreover, the second extruder 120 includes a second cylinder 121 having a second screw 122 rotating by motive power, and a cooling device 123 for cooling the second cylinder 121 to cool the resin melt to optimal temperature for reaction.

An outlet of the first extruder 110 and an inlet of the second extruder 120 are connected with each other by a cross pipe 130, and an extrusion die 140 for extruding and molding the resin melt is mounted at an outlet of the second extruder 120.

The first extruder 110 serves to melt the resin raw material supplied through the hopper 114 by the heating device 113 in order to manufacture resin melt in which the foaming agent and the additives are mixed uniformly, and the second extruder 120 serves to cool the resin melt supplied from the first extruder 110 to proper reaction temperature by the cooling device 123 in order to provide flow characteristics suitable for foaming.

In this instance, the flows of the resin melt in the first extruder 110 and the second extruder 120 are drag flows by the first screw 112 and the second screw 122, and the flow of the resin melt in the cross pipe 130 which connects the first extruder 110 and the second extruder 120 with each other is a plug flow by pressure.

The tandem foaming extruder 100 having such a transfer structure is remarkably low in throughput rate per unit time compared with that of conventional foaming extruders. The main cause of such a problem is a drop of transfer pressure due to frictional force between the inner surface of the cross pipe 130 and the resin melt.

In order to solve the above-mentioned problem, first, a surface roughness of the inner surface of the cross pipe 130 is within the range of 0.07 to 20 μm based on the center-line average roughness (Ra).

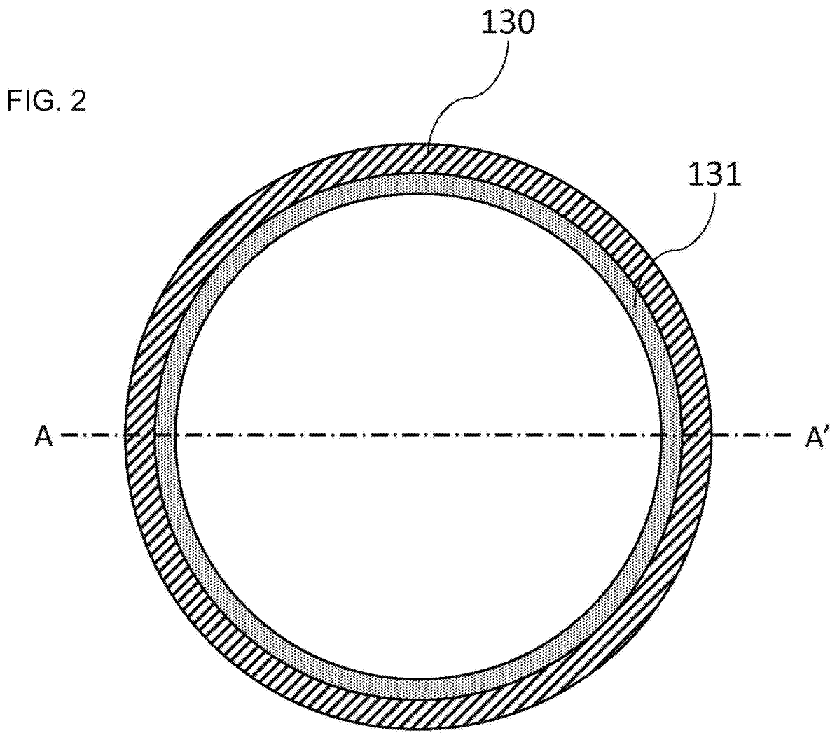

During internal processing of the cross pipe 130, as shown in FIG. 2, a low friction coating layer 131 of 0.002 to 20 mm thickness is formed on the inner surface of the cross pipe 130. Preferably, the low friction coating layer 131 is made of hard chromium or inorganic matters, such as zinc, nickel, nickel Teflon, and so on, which have low frictional coefficient.

Low shear stress is applied to the resin melt due to reduction of frictional force by the low friction coating layer 131 formed on the cross pipe 130. Therefore, it improves the flow characteristics of the resin melt in the cross pipe 130 so as to remarkably reduce back-flow to the first extruder 110.

The reduction in back-flow to the first extruder 110 means reduction of pressure drop of the resin melt in the cross pipe 130. Finally, the resin melt is smoothly supplied to the second extruder 120 so that the throughput rate per unit time of the tandem foaming extruder 100 is increased.

In the meantime, because the flow characteristics of the resin melt in the cross pipe 130 is improved, the cross pipe 130 can be designed to be extended considerably compared with the conventional tandem foaming extruder 100 of which the cross pipe 130 is not extended due to the problem of pressure drop.

Because the extended cross pipe 130 makes the resin melt secure sufficient residence time that the resin melt can have thickness reaction, it can greatly enhance productivity in the foaming extrusion process of thermosoftening plastics like nylon resin which require sufficient reaction time.

(Experiment 1)

In order to manufacture a polystyrene foamed board which can be used as a thermal insulation material, the tandem foaming extruder 100 was used.

A screw diameter of the first extruder 110 was 100 mm, a screw diameter of the second extruder 120 was 130 mm, and a length and a diameter of the cross pipe 130 were respectively 1000 mm and 50 mm. The surface roughness of the inner surface of the cross pipe 130 was Ra 0.5 mm, and the surface had no processing. A T-die for discharging the form of a board was mounted at the rear end of the second extruder 120.

A polystyrene foamed board of 30 kg/m³ density was extruded by adding 10 parts by weight of physical foaming agent, 1 parts by weight of talc as a nucleating agent, 1 parts by weight of coloring pigment, and 5 parts by weight of a charring agent with respect to 100 parts by weight of polystyrene resin.

The polystyrene foamed board having a normally foamed cell structure and mechanical property showed the throughput rate of 250 kg per unit time.

(Experiment 2)

The tandem foaming extruder 100 with the same size as the Experiment 1 was used, and a polystyrene foamed board was extruded using the same raw materials under the same processing conditions.

However, the surface roughness of the inner surface of the cross pipe 130 was lowered to Ra 0.2 μm, and a low friction coating layer 131 was formed using hard chromium.

The polystyrene foamed board having a normally foamed cell structure and mechanical property showed an improved throughput rate of 330 kg per unit time.

(Experiment 3)

In order to manufacture a Nylon foamed sheet of 5 mm thickness, the tandem foaming extruder 100 was used.

A screw diameter of the first extruder 110 was 100 mm, a screw diameter of the second extruder 120 was 130 mm, and a length and a diameter of the cross pipe 130 were respectively 1000 mm and 50 mm. The surface roughness of the inner surface of the cross pipe 130 was Ra 0.5 mm, and the surface had no processing. A round die for discharging the form of a sheet was mounted at the rear end of the second extruder 120.

A Nylon foamed sheet of 200 kg/m³ density was extruded by adding 4 parts by weight of isobutane as a physical foaming agent, 1 parts by weight of talc as a nucleating agent, and 1 parts by weight of chain lengthener with respect to 100 parts by weight of Nylon 66 resin.

The Nylon foamed sheet having a normally foamed cell structure and mechanical property showed the throughput rate of 160 kg per unit time.

(Experiment 4)

The tandem foaming extruder 100 with the same size as the Experiment 3 was used, and a Nylon foamed sheet was extruded using the same raw materials under the same processing conditions.

However, the length of the cross pipe 130 was extended to 3000 mm, the surface roughness of the inner surface of the cross pipe 130 was lowered to Ra 0.2 μm, and a low friction coating layer 131 was formed using hard chromium.

The Nylon foamed sheet having a normally foamed cell structure and mechanical property showed an improved throughput rate of 200 kg per unit time.

| | | Cross Pipe | | | |
|---|---|---|---|---|---|
| | | | Surface | Surface | Throughput |
| | Product | Length | Roughness | Coating | Rate |
| Exp. | polystyrene | 1,000 mm | Ra 0.5 mm | none | 250 kg/h |
| 1 | foamed board | | | | |
| Exp. | polystyrene | 1,000 mm | Ra 0.2 μm | Hard | 330 kg/h |
| 2 | foamed board | | | cromium | |
| Exp. | Nylon | 1,000 mm | Ra 0.5 mm | none | 160 kg/h |
| 3 | Foamed sheet | | | | |
| Exp. | Nylon | 3,000 mm | Ra 0.2 μm | Hard | 200 kg/h |
| 4 | Foamed sheet | | | cromium | |

As shown in the above experiments, when the surface roughness of the inner surface of the cross pipe 130 was lowered and the low friction coating layer 131 was formed, the polystyrene foamed board increased the throughput rate per unit time by 32%, and the Nylon foamed sheet increased the throughput rate per unit time by 25%.

Furthermore, even though the length of the cross pipe 130 was extended in order to secure the sufficient reaction time of the Nylon 66 resin, the throughput rate of the Nylon foamed sheet was not reduced but increased.

While the exemplary embodiments of the present invention have been described with reference to the accompanying drawings, but the present invention is not essentially limited to the exemplary embodiments. Additionally, it will be understood by those of ordinary skill in the art that various modifications, changes and equivalents may be made without deviating from the technical spirit or scope of the invention.

What is claimed is:

1. A tandem foaming extruder, which includes a first extruder, a second extruder, and a cross pipe connecting the first extruder and the second extruder with each other in series,
wherein a low friction coating layer with constant thickness is formed on the inner surface of the cross pipe.

2. The tandem foaming extruder according to claim 1, wherein the low friction coating layer has 0.002 to 2 mm thickness.

3. The tandem foaming extruder according to claim 1, wherein the low friction coating layer is made of any one among hard chromium, nickel, zinc, and nickel Teflon.

4. The tandem foaming extruder according to claim 1, wherein the cross pipe has 1,500 to 20,000 mm length.

5. The tandem foaming extruder according to claim 4, wherein a surface roughness of the inner surface of the cross pipe is within the range of 0.07 to 20 μm based on the center-line average roughness (Ra).
